(19) United States
(12) Patent Application Publication
(10) Pub. No.: US 2006/0085504 A1
(43) Pub. Date: Apr. 20, 2006

(54) A GLOBAL ELECTRONIC MAIL CLASSIFICATION SYSTEM

(76) Inventors: Juxing Yang, Boxborough, MA (US); Caixia Jiang, Boxborough, MA (US)

Correspondence Address: JUXING YANG, 115 COLONIAL RIDGE DRIVE, BOXBOROUGH, MA, 01719, US

(21) Appl. No.: 10/904,028

(22) Filed: Oct. 20, 2004

(51) Int. Cl. G06F 15/16

(52) U.S. Cl. 709/206

(57) ABSTRACT

A global email classification system enables email messages to be classified based on various factors into many categories. The global email classification system includes email classification servers, email classification clients, and other components. Personal email messages are in a special category. This invention includes a method to classify email messages into personal email messages and non-personal email messages. In an email classification system, an email message is processed by the email sender classification client before it is sent out. The email sender classification client requests a challenge object from the email classification server. The challenge/response process plus other factors determines the email classification. The challenge/response result is stored in the email classification server as an email data object. Before the email is delivered to the email recipient, the email recipient classification client processes the email and obtains the email classification code from the email classification server. The email recipient is informed the email classification by the email recipient classification client. A global email classification system requires coordination of many email classification systems. The coordination mainly involves moving and accessing email data objects from different simple email classification systems.

### CROSS REFERENCE TO RELATED APPLICATIONS

Not Applicable

### FEDERAL RESEARCH STATEMENT

Not Applicable

### FIELD OF INVENTION

This invention relates to electronic mail, specifically to electronic mail security, filter, classification, and user productivity.

### PRIOR ARTS

Electronic mail (email) is part of everyday life for almost everyone with access to a computer network such as the Internet. Email has become an indispensable tool for people to communicate with each other. For each electronic mail message, there is a sender and recipients. The current email system simply transmits an email message from the sender's system and deposits it in the recipient's system. In this invention, the term “system” or “computer” represents any electronic device that may be used to send and/or receive an email message. This includes computers, personal digital assistants (PDAs), cell phones, etc. In this invention, email messages mean any electronic documents and messages that can be transmitted through an electronic network. In general, email recipients have very little control in accepting incoming email messages. Due to large volume of daily email messages in an email user's mailbox, the email user faces following issues: which email to keep, which email to discard, and which email to read first. An email user may receive a lot of unsolicited email messages from unknown senders. Most of these email messages are considered “junk” email messages because they are not useful to the email recipient. Some of these email messages are intended to defraud email recipients financially. Once in a while, email worms or viruses are attached to email messages and spread among email users. They may inflict severe damage to email user's computers when these email messages are opened. Sometimes these worms and viruses can bring down a corporation's network resulting in huge financial losses to the corporation due to lost work, reduced productivity, and cost of system repairs. As the percentage of unsolicited email messages in an email user's mailbox increases, the email user's productivity decreases. For simplicity, all “junk” email messages, email worms and viruses, and unsolicited email messages are classified as junk email messages in this invention. Many methods have been used to combat junk email messages. Most of these methods use filters in the email recipient's mailbox or in the email relay servers. There are many sophisticated ways to design email filters such as a method described in U.S. Pat. No. 5,999,967 to Sundsted (1997). Most popular email programs include various filter functionalities. However, email filters are not very effective. Junk email senders have found ways to bypass email filters all the time. This is evidenced by the growing number of junk email messages despite of email filter improvements. Another group of methods is designed to guarantee the integrity of an email itself. Digital signature is the best way to verify an email sender's identity. U.S. Pat. No. 6,640,301 to Ng (2003) and U.S. Pat. No. 6,327,656 to Zabetian (2001) describe methods for email recipients to verify email integrity. However, these methods do not prevent junk email messages. In fact, junk email messages can pass these systems because junk email messages do not have to change during the email delivery process. It is not difficult for junk email senders to hijack legitimate user accounts to send junk email messages. These email messages can be certified by these methods.

### OBJECTS AND ADVANTAGES

This invention describes a global email classification system. There are many ways to classify email messages depending on personal preferences. For example, email messages can be classified as business, private, personal, junk, work, family, kid, etc. The global email classification system can be used to classify email messages into arbitrary categories defined by any organization or email users. The global email classification system classifies email messages based on email sender side information, email recipient side information, and/or email contents.

In this invention, a specific classification method of email messages is described. To further describe this invention we need to introduce the definition of a new concept, the read-worthiness level (RWL) of email messages:

An email user is presented with two email messages A and B. If the email user prefers to read email message A first than email message B, we mark the email message A as having a higher read-worthiness level than email message B. If the email user has no preference of reading email message A first or email message B first, the read-worthiness levels of these email messages are equal. We use “W” to denote the read-worthiness level of an email. For example, the read-worthiness level of email message A of recipient joe@xyz.net is denoted as W(A, joe@xyz.net).

In this invention, an email classification method based on RWL is described in details. In general, RWL depends on recipients, email contents, and other factors. For most email users, the more personal an email message is, the higher its RWL is. In postal mail, a hand-written letter is more personal than a printed letter. Likewise if an email system can verify that an email message is sent personally by its sender and is not sent automatically by a computer program, the email system can mark that email message with an appropriate RWL for its recipient. To be precise, a non-personal email message is defined as an email message that is constructed and sent without human interventions. Non-personal email messages include all junk email messages, computer generated email messages, and so on. Any email message that is not non-personal email is defined as a personal email message. To send a personal email message, a human being must physically initiate the email posting operation, e.g., clicking on the send button in an email program. This invention describes a method to identify and verify personal email messages.

Since this invention can classify email messages into personal messages and non-personal messages and can block non-personal messages, the invention at least solves the following issues for an email recipient,
(1) Prevention of the spreading of computer worms. Computer worms are mainly spread via email systems. When an unsuspicious recipient views a message containing a worm, the worm spreads by replicating itself and sending new worms to other peoples in the recipient's address book. Worms spread without the knowledge of the recipient. Using this email classification system, each personal email message must be sent by a sender's manual operation. Thus the worm cannot spread.
(2) Prevention of junk email messages. Junk email operators often hide their identity by hijacking other computers without the computer owner's knowledge. They use these computers to generate large volume of junk email messages. Since the email classification system may require the sender to send email messages manually, these junk email messages could not be classified as personal email messages and could be easily filtered out by email recipients.

There are other uses of this invention based on read-worthiness level of email messages and personal email concepts such as a more efficient way to store or sort email messages.

To identify and classify email messages into personal email messages and non-personal email messages, a global email classification system controls how email messages are sent on the email sender side of an email system. When an email sender wants to send an email message, the global email classification system issues a classification challenge to the email sender before the email message leaves the sender's system. The sender's system needs to send a classification response back to the global email classification system. Based on the sender's response, the global email classification system designates the email with a RWL. For example, if the sender's response is correct, the global email classification system may classify the email message as a personal message. Otherwise, the email is classified as non-personal. The global email classification system may also block the email message from leaving sender's system if the response is not correct. The email classification is stored in the global email classification system, not in the email message itself. The email message content is not modified in any way. This is to avoid a malicious attacker modifies the email classification in the email delivery system. When the email message is delivered to its recipient's mailbox, the recipient's email system automatically queries the global email classification system to get the email message classification.

For the global email classification system to classify an email message as a personal email message, a challenge must satisfy the following condition: to response to the challenge correctly, a human being must be physically present at the sender's system and manually create the response. The distorted text image challenge satisfies this condition.

A distorted text image is a digital image showing distorted text. The distorted text in the distorted text image is not recognizable by any computer or optical character recognition (OCR) system. However the distorted text is recognizable by human beings. There are many ways to generate distorted text. For example, a text image is created using regular font such as “Arial”. Then the text image is put through a low-band digital filter to smear the character lines in the image. The image could be warped. Random noise can be added in the image. The result is that the text image is distorted enough so that the text cannot be recognized by computers or OCRs, but it still can be recognized by human beings. An example of a distorted text image is shown in FIG. 11.

The response to the distorted text image is a text string using ASCII codes, UTF-8 codes, or other codes. In the example of FIG. 11, the correct response is a string “KT8BJ”. Since the text in the distorted text image is not recognizable by a computer or OCR, a human being must recognize the text in the distorted text image and manually type in the response.

### SUMMARY OF INVENTION

In accordance with this invention, a global email classification system classifies email messages into categories, specifically into personal email messages and non-personal email messages.

### BRIEF DESCRIPTION OF DRAWINGS

Brief description of figures.

FIG. 1 shows a simple email delivery system.

FIG. 2 shows a single server global email classification system.

FIG. 3 shows a flow chart for sending an email message.

FIG. 4 shows a flow chart for receiving an email message.

FIG. 5 shows a typical email data object.

FIG. 6 shows a typical email classification process.

FIG. 7 shows two email classification systems.

FIG. 8 shows two email classification systems with a classification relay service.

FIG. 9 shows an email data object forwarding process.

FIG. 10 shows an email classification relay process.

FIG. 11 shows an example of a distorted text image.

### BRIEF DESCRIPTION OF REFERENCE NUMERALS

1 email sender client

2 email recipient client

3 email server

4 email sender system

5 email recipient system

6 email sender classification client

7 email recipient classification client

8 email classification server

9 start sending an email message

10 email sender classification client receives an email message

11 email classification server responds to email sender classification client connection requests

12 email classification server authenticates an email sender

13 email sender classification client requests an challenge object

14 abnormal termination of sending an email messages by an email sender classification client

15 email classification server returns a challenge object

16 email sender classification client sends a response object

17 check if target response object and client returned response object match

18 update an email message

19 send a modified email message

20 return an error code

21 check if an email sender wants to retry for authentication

22 start downloading email messages

23 email recipient classification client starts downloading email messages

24 email recipient classification client connects to email classification server

25 email classification server responds to email recipient classification client

26 email classification server authenticates email recipient classification client

27 email recipient classification client authentication fails

28 email recipient classification client requests for classification code

29 email classification server returns classification code

30 email recipient classification client updates email messages

31 email recipient classification client checks for more email messages

32 email recipient classification client completes email receiving

33 email data object

34 start email classification

35 get the email data object based on email UUID

36 check if the email data object exists

37 check challenge object type in the email data object

38 classify email message as personal

39 classify other email messages as non-personal

40 email sender classification client A

41 email classification server A

42 email server A

43 email server B

44 email classification server B

45 email recipient classification client B

46 classification relay service

47 response objects match

48 check for email recipient account

49 check for permission of email recipient

50 forward an email data object

51 end forwarding process

52 request for email classification

53 search for email data object

54 query next classification relay service

55 end classification relay process

### Single Server Embodiment

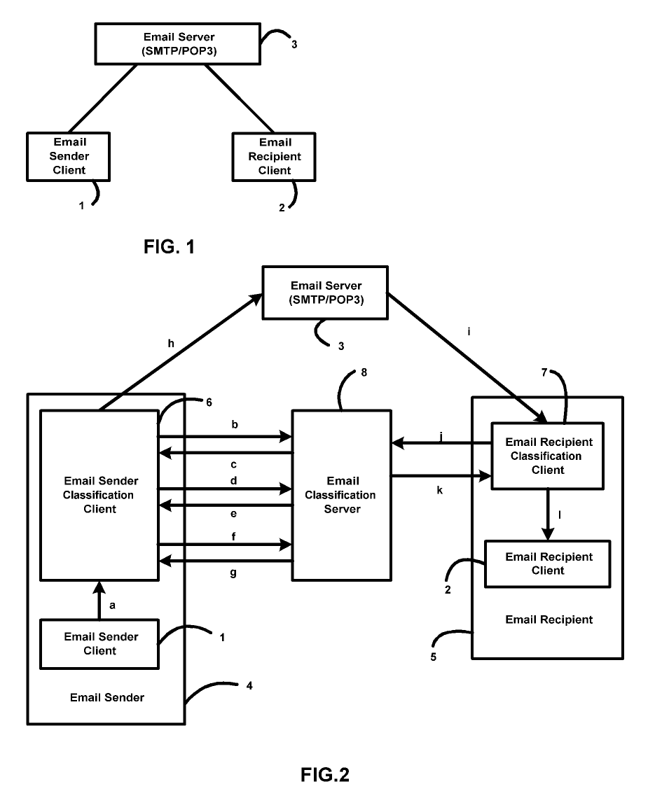

A simple email system is shown in FIG. 1. In this system a single email server (3) is used to deliver email messages between two email clients. Note that in this invention terms “server” and “client” mean logical server and client respectively. Physically they may reside in the same computer or different computers. When email sender client (1) sends email messages to email recipient client (2), it communicates with the email server via Simple Mail Transport Protocol (SMTP). SMTP is described in details in RFC 2821, Klensin, J, April, 2001. The email server stores the email message in the mailbox of email client 2. When email recipient client (2) needs to download its email messages from the email server, it communicates with the email server via Post Office Protocol Version 3 (POP3). POP3 is described in RFC 1939, J. Myers, M. Rose, May, 1996. Although FIG. 1 shows only one email server, in practice there could be many email servers and email gateways between an email sender and an email recipient. In addition, an email server may serve many email clients. There are many commercial email clients available such as Microsoft Outlook and Eudora. Most email clients have combined functions of email sender client and email recipient client.

A single server global email classification system consists of a single email classification server (8), a sender classification client (6), and a recipient classification client (7). Each email client must have a sender classification client and a recipient classification client for sending and receiving email messages. The email classification server can be integrated with the email server as a single server or run standalone in a separate process. Similarly the sender classification client and the recipient classification client can be integrated with the email clients or run standalone in a separate process. Integrated email classification and integrated email classification clients provide better user experience. The standalone approach provides easier implementation.

FIG. 2 shows a typical single server global email classification system. Note that the email classification server could be run in the same physical box as the email server. Alphabets next to arrow-head lines represent event flows when an email message is sent in this system.

a. Email sender client (such as MS Outlook) (1) prepares an email message and sends it out to the email sender classification client (6) via SMTP. Email sender classification client is a SMTP server from the email client perspective. When the email sender classification client receives the email, it extracts the “FROM” and “TO” fields from the email message. It may also calculate a unique signature value of the email message depending on the client configuration.

b. The email sender classification client authenticates itself to the email classification server (8) using a user name and a password. It sends “FROM” and “TO” fields and the signature value if applicable to the email classification server. The user name and the password are specific to the email sender on the email classification server.

c. If the classification server authenticates the user name and the password, it returns a status code to the email sender classification client including a universal unique identifier (UUID). The email classification server creates an email data object and stores it in a table using UUID as the search key. Otherwise, it returns an error code.

d. If step (c) is successful, the email sender classification client sends the classification server a request for a challenge object.

e. The email classification server generates a pair of a challenge object and a target response object. Note that the meaning of these objects are the same as those described in any Object Oriented Programming. The email classification server stores the target response object, “FROM” and “TO” fields, and the signature value if applicable in the email data object. The email classification server sends the challenge object back to the email sender classification client and wait for the email sender classification client's response.

f. The email sender classification client creates a response object and sends the response object to the email classification server. Depending on the challenge object, the email certification client may require a user manually enters a response. This manual process requires a user to be physically present at the client and enter or type in the response.

g. The email classification server verifies if the client's response object matches the target response object. If there is a match, the email classification server returns a confirmation to the email sender classification client. If there is no match, the email classification server returns an error code indicating the mismatch and the email sender classification client may repeat steps (d)-(g). Users are allowed to cancel this process. If the process is canceled, the response to the certification server indicates so and the email may be sent as an ordinary email without classification. The process described in steps (d)-(g) is called a challenge/response process.

h. The email sender classification client adds the UUID to the email header. It then posts the email message to the email server (3). Email server could be a regular SMTP server. It does not have to know anything about email classification client and server. The email server stores the email message in the recipient's mailbox.

i. When the email recipient client (2) downloads the email message from the email server, the request should go through the email recipient classification client (7). The email recipient classification client downloads the email before forwarding it to the email recipient client.

j. The email recipient classification client extracts the UUID from the email message. It authenticates itself with the email classification server using a user name and a password and sends UUID to the email classification server. The user name and the password are specific to the recipient on the email classification server. This step is called classification request.

k. The email classification server finds the stored email data object (33) associated with the UUID. It matches “FROM” and “TO” fields and the signature value if applicable. If they match, the email classification server sends the classification code to the email recipient classification client. The classification code is partially based on the type of challenge object and the response object. Otherwise the email is not classified. This step is called classification response. In addition to classifying this email message, the email classification server may issue a challenge to the email recipient classification client. A correct response serves as a receipt of the email message. This information may also be saved in the email data object. The email sender classification client may access this information whenever the email sender needs it.

l. Based on the email classification, the email recipient classification client modifies the email message to indicate the classification of the email. The email message is delivered to the email recipient client. The email recipient client may display email messages according to their email classifications.

Email Sender/Recipient Classification Clients

Email send/recipient clients behave like SMTP/POP3 servers and clients. To the email clients, they are SMTP/POP3 servers. To the email servers, they are SMTP/POP3 clients.

Without the email send/recipient clients, email clients connect to SMTP servers for sending email messages and POP3 servers for downloading email messages. With email sender/recipient classification clients, email clients connect to email sender/recipient classification clients as their new SMTP/POP3 servers. Email sender/recipient classification clients connect to the original SMTP/POP3 servers on behalf of email clients. In order for an email sender classification client to present a challenge to an email sender, the email sender classification client must be installed and run on the same computer as the email sender client.

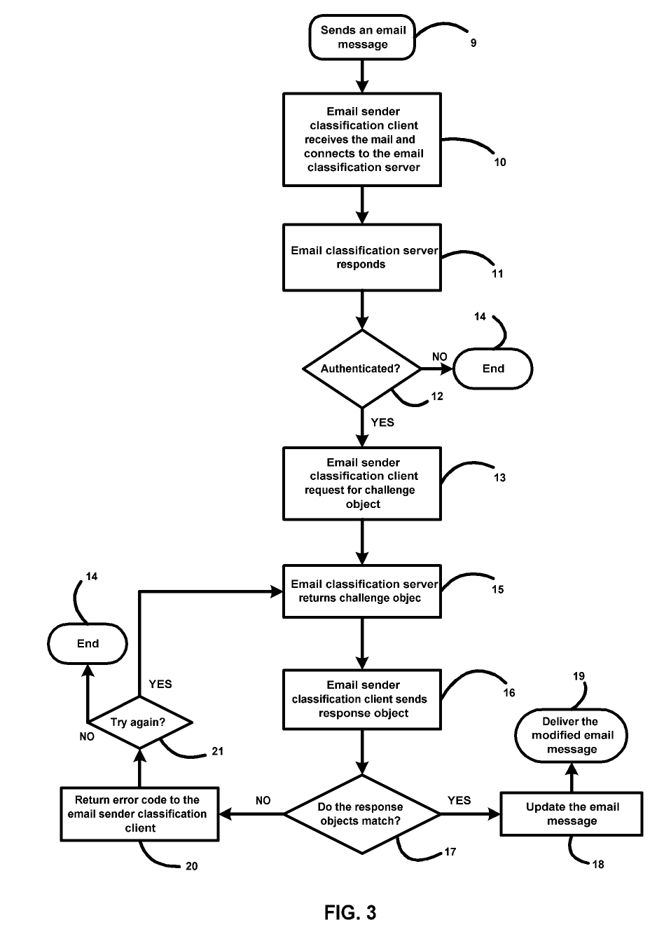

FIG. 3 shows the flow chart for sending an email message. The detailed description is as follows:

(9) When an email sender client (1) sends an email message, it sends the email message to the email sender classification client (6).

(10) The email sender classification client receives the email message. The email sender classification client extracts the “FROM” field and “TO” field from the email message as needed. Depending on the configuration of the email sender classification client, it may compute a signature value based on the content of the email. A 32-bit Cyclic Redundancy Code (CRC) number can be used as a signature value. The email sender classification client sends a user name and a password, “FROM” and “TO” fields, and/or the signature value to an email classification server (8).

(11) The email classification server verifies the user name and the password. These user name and password are not the same as the sender's email STMP/POP3 user name and password. The sender's email address may be used as the sender's user name on the email classification server. If the sender is authenticated by the user name and the password, the email classification server creates a universal unique identification number (UUID) and an email data object. The UUID is used as the key to access the email data object. The email classification server stores the “FROM” and “TO” fields and the signature value in the email data object. The email data object itself is stored in a table for easy access.

(12) If the sender is authenticated, the email classification server sends a success code and the UUID to the email sender classification client. If the sender is not authenticated, it sends an error code.

(13) The email sender classification client sends a request for a challenge object to the email classification server. One particular type of challenge objects is an distorted text image. The image could be a gray scale image. For simplicity, the text in the image could be six characters of alpha-numerical characters.

(14) If the sender is not authenticated, the email sender classification client may send the email to the SMTP server without any modification to the email message, may block and drop the email, or may take any other action depending on the configuration of the email sender classification client.

(15) The email classification server creates a challenge object and a corresponding target response object. It stores the target response object in the email data object. The email classification server sends the challenge object to the email sender classification client.

(16) The email sender classification client generates a response object based on the challenge object. The sender may need to create the response object for the email sender classification client. The email sender classification client sends the response object to the email classification server.

(17) The email classification server checks if the response object matches the target response object. It sends the email sender classification client a status code to indicate if there is a match.

(18) If the response objects match, the email classification server marks the email data object as valid and the email sender classification client adds the UUID in the email message as a custom email message field. The field name could be “x-classification-uuid”. If the signature value is computed, another email message field is added. The field name could be “x-classification-signature-value”. The data could be a string “yes”. This is to inform the email recipient classification client that the email classification server contains a signature value. The email recipient classification may want to calculate the signature value and submit the value to the email classification server for verification.

(19) The email sender classification client sends the modified email message to the email (SMTP) server (3) for delivery to the recipient.

(20) If the response objects do not match, the email classification server sends an error code to the email sender classification client.

(21) The email sender classification client may request another challenge object from the email classification server and try again. The new challenge object should be different from the previous one. It may stop the retry if there are too many retries already depending on the configuration of the email sender classification client.

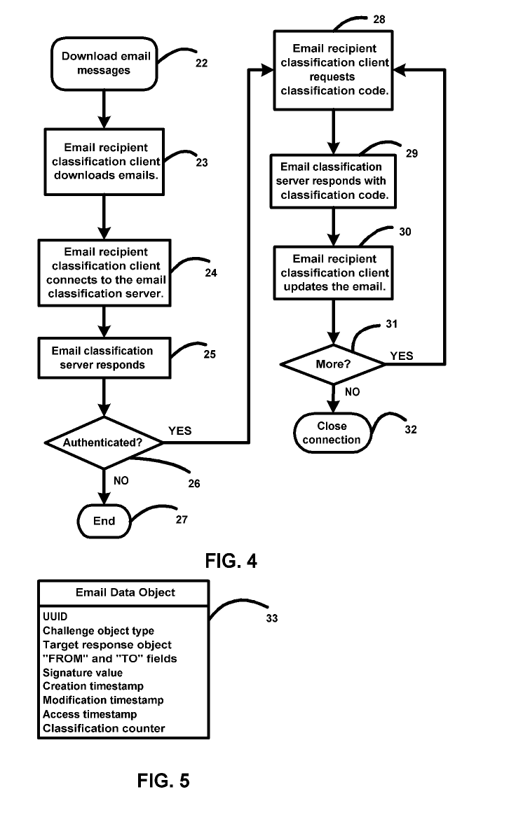

The email recipient classification client may be integrated with the email POP3 server or the email client. It may reside in the POP3 server computer or the email client computer. FIG. 4 shows a flow chart for the email recipient classification client. The details are as follows:

(22) An email recipient client (2) starts the email downloading process. The email recipient client uses an email recipient classification client (7) as its POP3 server.

(23) The email recipient classification client downloads recipient's email messages from the original POP3 server.

(24) The email recipient classification client connects to an email classification server (8) and sends it the recipient's user name and password.

(25) The email classification server authenticates the recipient using the user name and password. It sends a success code to the email recipient classification client if the recipient is authenticated. Otherwise it sends an error code.

(26) The email recipient classification client checks the authentication code.

(27) If the authentication fails, the email recipient classification client may deliver the unmodified email to the email recipient client, may extract the email fields added by the email sender classification client and deliver it to the email recipient client, or may take other actions.

(28) If the recipient is authenticated, the email recipient classification client extracts UUIDs and signature value indicator if applicable from email messages. If signature value indicator indicates the email recipient classification client should compute a signature value for an email message, the email recipient classification client should do so. The email recipient classification client sends UUIDs, “FROM” and “TO” fields, and signature values to the email classification server.

(29) The email classification server finds email data objects based on UUIDs. The email classification server authenticates email messages based on UUIDs, “FROM” and “TO” fields, and signature values. The email classification server computes classification codes for email messages based on all data in email data objects and email authentications. The email classification server sends email classification codes to the email recipient classification client. In addition, the email classification server may issue a challenge object such as a distorted text image to the email recipient classification client. The correct response object serves as a receipt for the email message delivery.

(30) The email recipient classification client adds email classification codes into email messages. If the email recipient classification client is integrated with the email client, icons or symbols may be used to indicate different email classification code in the email client. If they are not integrated, the email recipient classification client may add classification code and description in the subject line of an email message or other part of the email message. Further email classification information may be added in the email message. For example, an URL may be added in an email message to direct users to get more information about email classifications. Then the email message is delivered to the email recipient.

(31) The email recipient classification client checks if there are more email messages waiting to be classified. If there are more email messages, it repeats steps (28)-(31).

(32) If there are no more email messages waiting to be classified, the email recipient classification client closes the connection to the email classification server.

Email Classification Server

The email classification server plays a central role in a global email classification system. The email classification server manages user accounts including user names and passwords, maintains email data objects, creates challenge objects, classifies email messages, and performs other tasks.

Each of these tasks can be configured to suit needs of different installations. A server configuration tool is used to configure the email classification server and an email monitor tool is used to monitor the status of the email classification server.

The server configuration tool provides the user interface for managing user accounts. It also manages a list of challenge object types. A user account may include a challenge object type. The type of challenge object is used for email classification. The server configuration tool may configure the properties of challenge objects. For example, the configuration tool may specify the number characters in distorted text image objects. The configuration tool may configure other aspects of the email classification server for it to function as described. For example, it may configure the necessary IP addresses and port numbers of the email classification server for the communication between the email classification server and the email sender/recipient classification clients.

The email monitor tool is used to provide a visual display of status of the email classification server. This may include real-time data and historical data. For the real-time data, it may display the number of connected users, the number of challenge objects created in one-minute intervals, the number of email classification done in one-minute intervals, etc. For the historical data, it may display the number of user connections in the last week, last month, and last year. Other real-time data can be displayed in the historical data for last week, last month, and last year, etc. These data can be displayed on a per user basis.

An email data object (33) is shown in FIG. 5 is created when an email sender is authenticated. The email object is identified by its UUID. In addition to previously described data in an email data object, it may contain following data: a creation timestamp, a modification timestamp, and an access timestamp. Since one email message may have multiple recipients, the email data object maintains a classification counter. Every time an email recipient classification client requests for classification of the email message, the classification counter increments. The number of classification requests for an email cannot be determined when the email is sent because recipients of the email may contain a mailing list and the same email may be downloaded from the POP3 server multiple times. Sometimes, it is desirable to remove an email data object when the email data object has not been accessed after a period of time. When an email data object is created it is stored in the memory of the email classification server. To conserve the system resource of the email classification server, email data objects are moved from the memory to more permanent storage such as hard disks. If the challenge/response process fails, the email data object is removed.

In addition to keeping a classification counter, an email data object may also maintain a list of recipients that have requested for email message classification. The email sender may use this information to determine which email recipient received the email message. Furthermore an email classification server may issue a challenge object to an email recipient so that a correct response object serves as an acknowledgement of recipient of the email message. Again a distorted text image is a suitable challenge object. This is similar to a package delivery person delivering a package to an address. Someone at the address signs receipt for receiving the package.

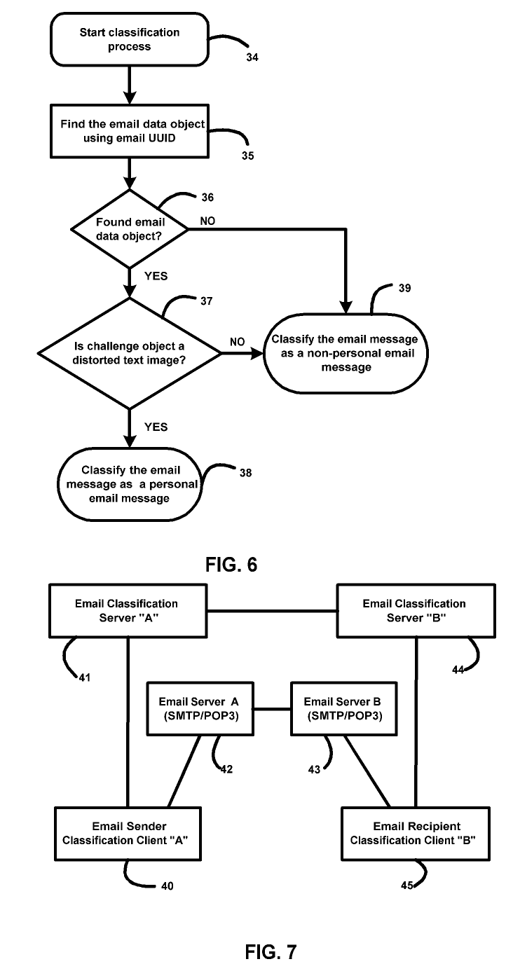

One of tasks of the email classification server is to classify email messages based on data contained in email data objects. It is expected that different organizations and email users may classify email messages differently. Therefore there is no single method to classify email messages. FIG. 6 shows a typical flow chart for classifying email messages into personal and non-personal messages.

(34) If the email classification server receives an email classification request from an email recipient classification client, it starts the classification process.

(35) The email classification server searches for the email data object based the email UUID.

(36) Check if the email data object exists.

(37) The email classification server obtains the challenge object type from the email data object. It checks for the challenge object type.

(38) If the challenge object type is distorted text image or similar type that requires a human being to construct a response object, the email message is classified as personal email message.

(39) If the email data object does not exist or the challenge object type is not a distorted text image or similar type, it is classified as non-personal email messages.

The email classification server may be integrated with the email server by expanding the SMTP protocol or other means.

In addition to email classification related data, an email object may store other information regarding an email such as how urgent a reply is needed. This information can be passed to the email recipient along with the classification response.

Comminication Protocols

Many communication protocols between an email sender/recipient classification client and an email classification server can be used. TCP/IP is recommended as the transport layer protocol.

To protect the integrity of the global email classification system, it is recommended that data communication between an email classification server and an email sender/recipient classification client be encrypted. One method is to use Secure Socket Layer (SSL) or Transport Layer Security (TLS). HTTPS may be used. It is an existing protocol for secure communication that combines HTTP and SSL together. Data may be embedded in HTML forms. The email classification server could be built on top of a HTTPS server for quick development.

### Multiple Server Embodiment

A single server email classification system cannot classify email messages if their senders and recipients use different email classification servers. A multiple server email classification system enables email messages among these email users to be classified. A multiple server email classification system consists of several single server email classification systems.

Since more than one email classification serve may generate UUIDs for email data objects, it is necessary to add email classification server identifier as part of UUIDs. The host Internet address is a preferred choice for this purpose.

As shown in FIG. 7, email data objects in email classification server “A” are needed for email classifications by the email recipient classification client which is connected to email classification server “B”. There are several methods for the email recipient classification client to access the email data objects in email classification server “A”:

(a) The email recipient classification client (45) connects to email classification server “A” (41) directly. This is the simplest solution. In practice, this is often not possible because email classification server “A” may be behind a corporate firewall. Email classification server “A” may not have the recipient in its user accounts.

(b) Email classification server “B” (44) connects to email classification “A” (41) on behalf of the email recipient classification client (45). This method requires that email classification server “B” be authenticated by email classification server “A”. This is accomplished by creating a user account on email classification server “A” for email classification server “B”. This method works if both email classification servers are within a corporate firewall. The detailed classification procedure is almost the same as shown in FIG. 4. There is no procedure change in how the email recipient classification client requests for email classifications. Since email classification server “B” does not have the email data object, it queries email classification server “A” for the email classification code using the procedure described in FIG. 4.

(c) Using a third-party classification relay service, email classification servers from different corporations can communicate. A classification relay service may authenticate any email classification servers. A classification relay service contains a relay service table. The table contains email classification server identifiers and their corresponding relay services. A relay service may communicate with other relay services for any email classification server that is not in its relay service table. The classification relay service can be easily built into an email classification server. An email recipient classification client queries its email classification server for email message classification. If the email classification server cannot classify the message, the email classification server queries its classification relay server on behalf of the email recipient classification client. The classification relay server may query other classification relay servers on behalf of the email classification server and indirectly on behalf of the email recipient classification client. Any server that queries email message classification on behalf of an email recipient classification client is called an email recipient classification client's representative.

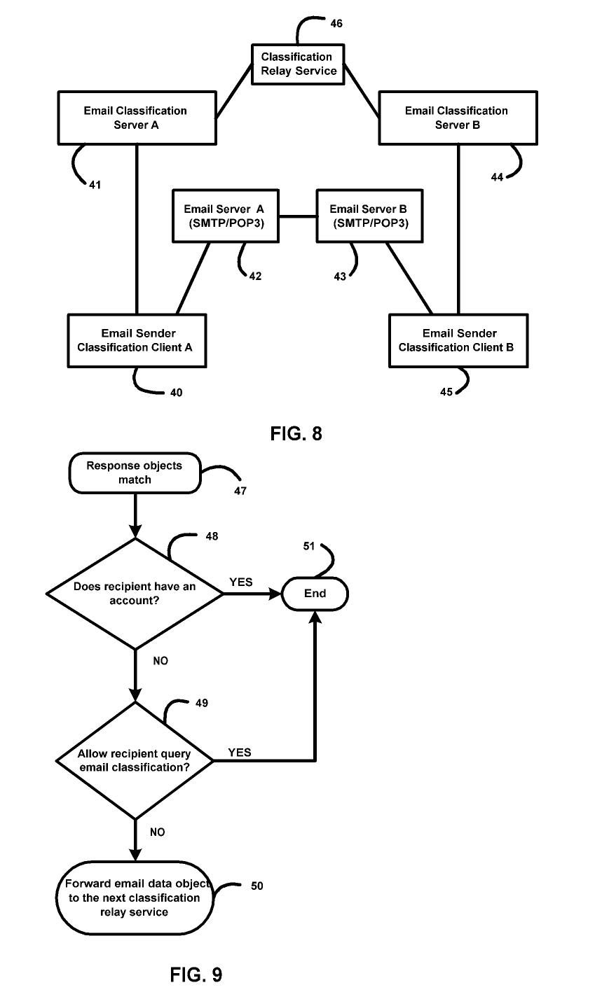

In all three methods, there is no change in procedure for email recipient classification client as described in FIG. 4. Method (c) is mostly used for global email classifications. FIG. 8 shows an addition of a classification relay service to the system in FIG. 7. Email classification server “A” may forward email data objects to the classification relay service if email classification server “A” does not accept email classification queries from other email classification servers or recipient classification clients. This may be the case if the email recipient is outside of corporate firewall. To determine if email data objects forwarding is needed, an email classification server needs to do additional data processing in step (18) of FIG. 3. FIG. 9 shows the flow chart of this additional data processing:

(47) If response objects match in step 18 of FIG. 3, the email classification server does additional data processing.

(48) The email classification server checks if it has the recipient user account. The recipient user account is generally the recipient email address.

(49) If the email classification server does not have the recipient user account, it checks if it allows recipient's representatives to query email classifications. Recipient's representatives may include its email classification server and email relay services. The email classification server may refuse any email classification request from outside of a firewall.

(50) If the email classification server does not allow email classification request, it forwards the email data object to its classification relay service.

(51) If the email classification server accepts email classification request from one of recipient's representatives, it does not forward email data objects.

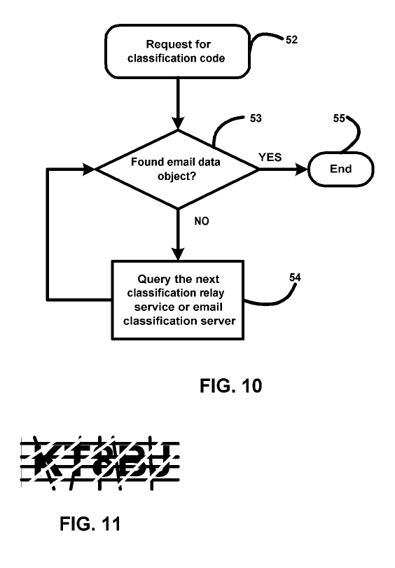

With classification relay services, additional data processing in the email classification server is needed in step (28) of FIG. 4. FIG. 10 shows the flow chart of this additional data processing:

(52) The email recipient classification client makes a request for email classification.

(53) The email classification server searches for the email data object in this storage using the email message's UUID.

(54) If the email classification server or the classification relay service cannot find the email data object, it queries its classification relay service for the email data object.

(55) If the email data object is found, the email classification code is returned to the requester.

Each classification relay service contains a relay service table of email classification server addresses and their corresponding relay services. Since an email message's UUID contains email classification server addresses, the table allows the classification relay service to find the next relay service that may have the email data object. The table may contain a default catch-all classification relay service address. It is preferable to use secure communication among classification relay services. Relay services may authenticate themselves to their peers using digital certificates. A network of relay services may update their relay service tables by sharing their tables with their peers.

Security and trust among classification relay services are very important. A rogue classification relay service may send fake classification response to other relay services and render the global email classification system useless. To prevent this from happening, a trusted classification relay service authorization server can be used to certify each classification relay service. For a new classification relay service to join the global email classification system, it must be authorized. The legal entity that is responsible for the new classification relay service may be asked to agree on a set of rules that governs the use of the global email classification system. The agreement is a legal document. It can be enforced in a court of laws. After the new classification relay service is authorized, it is assigned a digital certificate and is recognized by the classification relay service authorization server.

### CONCLUSION, RAMIFICATIONS, AND SCOPE OF INVENTION

A global email classification system is described in this invention. When email user community adopts this system, email users will get improved productivity and less frustration. This invention can be used as basis for classification of other types of messaging.

What is claimed is:

1. An electronic document classification system comprising of:
an universal unique identifier (UUID) generator for identifying an electronic document;
a challenge and response generator for generating challenge objects and corresponding target response objects;
an electronic document data object generator for generating an electronic document data object comprising of an UUID and a response object;
a data maintenance means for maintaining electronic document data objects and accessing and modifying electronic document data objects based on UUIDs;
a classification means for classifying electronic documents based on data contained in electronic document data objects;
whereby an electronic document is identifiable by an UUID;
whereby an electronic document object is accessible by said UUID;
whereby an electronic document is classifiable by a classification module based on said electronic document data object.

2. The electronic document classification system of claim 1 wherein:
the electronic document is an electronic mail (email) message;
whereby the electronic document classification server is used to classify email messages.

3. The electronic document classification system of claim 1 wherein:
the challenge object is derived from the target response object and can only be recognized by a human being;
a correct response object can only be constructed by a human being;
whereby a correct response object indicates that a human being is personally classifying an electronic document.

4. The electronic document classification system of claim 3 wherein:
the challenge object is an electronic image containing distorted target response object;
said electronic image is only recognizable by a human being and is not recognizable by a machine.

5. The electronic document classification system of claim 1 wherein:
the UUID comprising an identifier for identifying the electronic document classification server that generates the UUID.

6. The electronic document classification system of claim 1 wherein:
the electronic document data object further comprising a creation timestamp of the object, an access timestamp of the object, a modification timestamp of the object, a classification counter of the object, or a list of classification requesters;
whereby classification activity of the electronic document can be tracked.

7. The electronic document classification system of claim 6 wherein:
the data maintenance means further comprising means to move electronic document data objects from temporary storage to permanent storage;
whereby classification records and reports are obtained.

8. The electronic document classification system of claim 2 wherein:
the classification means classifies email messages into personal email messages and non-personal email messages;
whereby personal email messages are read first by email users.

9. The electronic document classification system of claim 1, further comprising:
a means for receiving electronic documents;
a means for delivering electronic documents;
whereby a sender of an electronic document can personalize an electronic document;
whereby a recipient of an electronic document can obtained classification of an electronic document from the electronic document classification system.

10. The electronic document classification system of claim 9, further comprising:
a means for acknowledging receipt of an electronic document by providing a correct response to a challenge;
a means for storing electronic document receipts;
whereby a sender of an electronic document is able to verify receipt of an electronic document.

11. The electronic document classification system of claim 1, further comprising:
a means to communicate with other electronic document classification systems;
a table having entries including an electronic document classification system identifier and corresponding next hop electronic document classification system identifier;
said table having a default entry with a next hop electronic document classification system identifier for all electronic document classification systems that are not in said table;
a means to update said table periodically so that said table contains latest information;
whereby electronic document classification is available across multiple electronic document classification systems.

12. The electronic document classification system of claim 11, further comprising:
classification relay services which relay email data objects and email classification request among themselves and email classification servers;
whereby a global electronic document classification system can be established.

13. A method for classifying electronic documents for delivery from an sender to multiple recipients, the method comprising the steps of:
starting an electronic document delivery;
requesting for a challenge object;
creating a challenge object and corresponding target response object;
creating an electronic document data object including an universal unique identifier (UUID) and said target response object;
responding to said challenge object;
tagging said electronic document with said UUID;
receiving said electronic document;
extracting said UUID from said electronic document;
searching for said electronic document data object using said UUID;
when said electronic document data object is found:
classifying said electronic document based on data in said electronic document data object;
whereby an electronic document is classified.

14. The method for classifying electronic documents of claim 13, further comprising:
signing a receipt of an electronic document by providing a correct response to a challenge;
whereby a sender is able to identify electronic document recipients.
